(19) United States
(12) Patent Application Publication
(10) Pub. No.: US 2009/0015556 A1
(43) Pub. Date: Jan. 15, 2009

(54) METHOD AND APPARATUS FOR INTERACTING WITH AN APPLICATION

(76) Inventor: Syed Zafar Kazmi, San Diego, CA (US)

Correspondence Address: SCHWEGMAN, LUNDBERG & WOESSNER, P.A., P.O. BOX 2938, MINNEAPOLIS, MN, 55402, US

(21) Appl. No.: 12/135,836

(22) Filed: Jun. 9, 2008

Related U.S. Application Data
(60) Provisional application No. 60/942,908, filed on Jun. 8, 2007.

(51) Int. Cl. G09G 5/08; G06F 3/02

(52) U.S. Cl. 345/159; 345/169

(57) ABSTRACT

Disclosed is a system by which a user of a device may input data. The system provides a method for users to become familiar with standardized entry of data and interacting with a user interface. By restricting the keys used in the system to those universally found on typical mobile phones, users can more rapidly adapt to interacting with various function.

### CROSS REFERENCE TO RELATED APPLICATION

This is a United States Patent Application that claims priority under 35 U.S.C. § 119(e) to United States Provisional Patent Application titled “A METHOD AND APPARATUS FOR INTERACTING WITH AN APPLICATION,” (Ser. No. 60/942,908) filed on Jun. 8, 2007, which is incorporated by reference in its entirety herein.

### FIELD

The present disclosure pertains, generally, to a method and apparatus for an application to interact with user on a mobile device.

### BACKGROUND

Hundreds of millions of cell-phones are in use around the world with the capability of running applications beyond the traditional usage as a phone. However, the applications face the challenge of using the limited keypad in a manner which can support application functions. Various attempts are being made, from added special “soft-keys” capable of changing functions to exotic keyboard designs. These innovations are usually specific to particular handsets or handset vendors and can not be applied to the users of phone devices in general. There are several data input methods in the art. Patents and patent applications such as US Patent Application 2003/0201982, US Patent Application 2003/0095096, U.S. Pat. No. 6,681,002, and U.S. Pat. No. 6,107,997, describe devices and methods by which a user may enter data. However, these methods do not solve the problems described above.

### BRIEF DESCRIPTIONS OF THE FIGURES

Example embodiments are illustrated by way of example and not limitation in the figures of the accompanying drawings.

FIG. 1 is a front view of a sample keypad on a device, according to an example embodiment.

FIG. 2 is a flow diagram displaying a series of inputs for BACKSPACE/DELETE, according to an example embodiment.

FIG. 3 is a flow diagram displaying a series of inputs for capitalization, according to an example embodiment.

FIG. 4 is a flow diagram of a sample menu layout, according to an example embodiment.

FIG. 5 is a block diagram of a machine in the example form of a computer system.

FIG. 6 is a block diagram of the components of a sample application.

FIG. 7 is a block diagram of a program in the example form of an application.

### DETAILED DESCRIPTION

The following description provides for a method and apparatus for an application running on a mobile device to interact with a user. In the description, numerous specific details are set forth in order to provide a more thorough understanding of example embodiments of the present invention. The description is provided so those of ordinary skill in the art, with the included description, may be able to implement and use the method and apparatus. It will be appreciated, however, by one skilled in the art that the invention that methods and processes described may be practiced in numerous variations without such specific details without departing from the invention. While the invention may be described as a particular embodiment, one skilled in the art may identify various modifications while still remaining within the scope of the invention.

Example embodiments provide a method for devices to allow users to enter data, perform functions, and navigate applications using the standard keys found on practically all phones and mobile devices. By providing a standard method of user input that is restricted to the keys found universally on mobile devices, programmers and device manufacturers are able to create applications that can accept complex inputs from limited keys.

### Overview

Some embodiments of the invention described techniques to interact with an application using a keypad of a mobile device. The application may require a user of a mobile device to enter information via the keypad. The keypad may be associated with software that enables the user to provide the information that could not be done with a typical keypad. The software may map all information required by the application to the keypad. This may enable the user to use a standard keypad of a mobile device to perform complex functions.

### Keypads

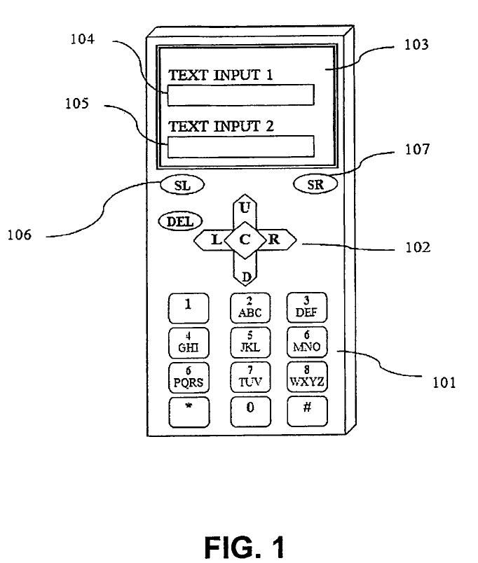

FIG. 1 illustrates a front view of a sample keypad on a device, according to an example embodiment. The embodiment depicted in FIG. 1 is an example of an apparatus to carry out the methods described herein. In one embodiment, the numeric keypad 101 is positioned at or adjacent the center and extending downward to the bottom edge of the device is a 3×4 grid layout with keys “1”, “2”, and “3” on the first row; “4”, “5”, and “6” on the second row; “7”, “8”, and “9” on the third row; and “*”, “0”, and “#” on the fourth row.

Positioned above the numeric keypad 101 is the directional keypad 102. The directional keypad 102 is a cross shaped series of keys, with the UP key positioned at the top segment; the DOWN key positioned at the bottom segment; the LEFT key positioned on the left segment; and the RIGHT key position on the right segment. Further embodiments may contain an additional CENTER key positioned at the intersection of the cross directly in the center of the directional keypad 102. Both the numeric pad keypad 101 and directional keypad 102 may be controlled by the input logic 601, which is discussed in further detail below.

International Telecommunications Union (ITU) is an international organization that sets standards in telecommunication technologies. ITU has assigned Roman alphabet letters A-Z to the standard numeric keypad. Letters ‘a’, ‘b’, ‘c’, appear on key 2; letters ‘d’, ‘e’, ‘f’, on key 3; ‘g’, ‘h’, ‘i’ on key 4; letters ‘j’, ‘k’, ‘l’ on key 5; ‘m’, ‘n’, ‘o’ on key 6; ‘p’, ‘q’, ‘r’, ‘s’ on key 7; ‘t’, ‘u’, ‘v’ on key 8; ‘w’, ‘x’, ‘y’, ‘z’ on key 9.

### Backspace/Delete

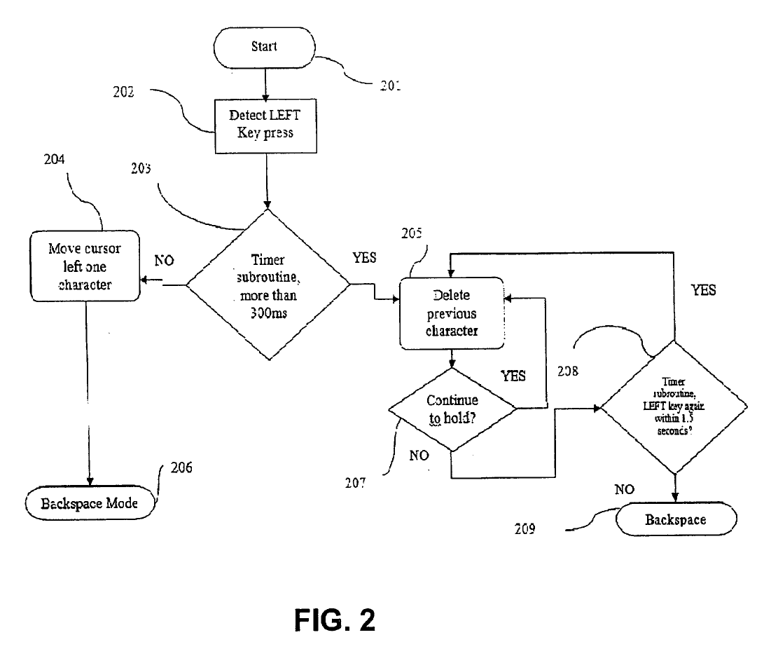

FIG. 2 illustrates a flow diagram displaying a series of inputs that would be detected by a device for inputting BACKSPACE and DELETE. The BACKSPACE and DELETE method may be controlled by the Backspace/Delete subprogram 702. The example method for moving the cursor left on the display 103 (illustrated in FIG. 1) can be used to accomplish two tasks: backspace and delete. The BACKSPACE operation moves the cursor left one character. The DELETE operation moves the cursor left and removes the previous character. Accordingly, the example application groups both functions together. Also, since both functions require moving the cursor to the left, it is intuitive for the user to understand that the LEFT key on the directional keypad 102 performs this task. The default mode of the LEFT key is BACKSPACE.

The method illustrated in FIG. 2 may start at block 201. The device may use the keypad detection component 711 to detect a user pressing the LEFT key, as illustrated in block 202. The application on the device may further include a timer subroutine 704. If the device's timer subroutine 704 detects that a user presses the LEFT key for more than a preset time (e.g., 300 ms in one embodiment), the software performs the DELETE function. This is illustrated in blocks 203 and 205

From this point, the device assumes that user will continue in DELETE mode and therefore changes the default mode to DELETE. While in DELETE mode, any further LEFT key press will result in the delete operation 205. The DELETE mode is reset to BACKSPACE mode if the device detects that either a key other than left on the keypad is pressed, or if no key is pressed for a period of time (for example, 1.5 second or more) 209. In order to indicate DELETE or BACKSPACE mode, the application on the device may change the look of the cursor or use some other visual indicator e.g. an icon at the bottom of display 103 that may be controlled by the display logic 602.

In one embodiment, the user may continuously hold the DELETE key, resulting in repeated character deletion. 207 In other embodiments, the option to hold down 207 may be omitted from the device's application to prevent accidental deletion of data. The above method describes an embodiment particular to languages that commonly read left to right. For languages which read from right to left, for example Arabic, the above method may substitute the RIGHT key for the LEFT key.

### Capitalization

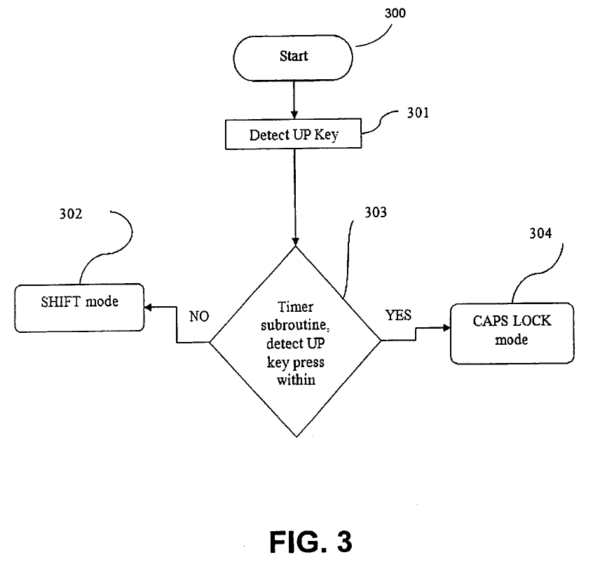

FIG. 3 illustrates a flow diagram displaying a series of inputs detected by a device for capitalization. Typically, the majority of characters entered as text are lowercase letters. However, occasionally users may need to change the capitalization of characters either for style or to enter abbreviations. Because this is not a frequent requirement, the device sets the default entry mode to lower case letters. Because capitalized letters are “uppercase letters,” a user will appreciate using the UP key on the directional keypad 102 to change the entry mode to uppercase.

The capitalization method may be handled by the capitalization subprogram 703 on the device. The method may start at block 300. When the device detects that the UP key is pressed up once, it changes the entry mode to SHIFT, as illustrated in block 302. In SHIFT mode, the character entered is switched from the current default mode. Hence, in lowercase mode, SHIFT mode will change the case of next entered character to uppercase. In the uppercase mode, SHIFT will change the case of next entered character to lower case. SHIFT mode is applicable only to the key pressed next. This mode is turned off after the first key is pressed. This behavior is analogous to a user pressing and holding the SHIFT key on desktop keyboard while pressing another letter.

When the device's timer subroutine detects the UP key pressed twice in rapid succession (e.g., less than 300 ms apart), CAPS LOCK mode is toggled, as illustrated in blocks 303, 304. By default the status of CAPS LOCK is off and therefore the default text entry mode is lowercase. However, when the CAPS LOCK mode is on, the default text entry mode is uppercase. This behavior is analogues to the CAPS LOCK mode on a desktop computer's keyboard. Further, CAPS LOCK mode may be deactivated by repeating the step of pressing the UP key twice in rapid succession. Similar to the method for BACKSPACE/DELETE, the CAPS LOCK and SHIFT mode may use a visual indicator on the device's display 103. In another example embodiment, the UP and DOWN key may be substituted with the “*” and “#” keys.

### Other Functions

Other functions commonly necessary for interacting with applications are SPACE, ENTER/RETURN, and BACK. The SPACE function allows a space character inserted. In an example embodiment, the SPACE function is assigned to the “0” key on the device's numeric keypad 101. The ENTER/RETURN function serves the same function as that of a desktop computer, typically as a submit command or carriage return operation. In an example embodiment, the ENTER/RETURN function may be assigned to the “#” key on the numeric keypad 101. In another embodiment, the CENTER key on the directional keypad 102, if available on a device, may also serve the identical ENTER/RETURN function. The BACK function serves as a return to a previous field when navigating through a series of fields. In an example embodiment, the BACK function may be assigned to the “*” key on the numeric keypad 101.

Inputting characters in an application when using a device of limited keys may require the switching of entry modes. For example, when a user is typing a message, the device may set an alphanumeric mode so letters and numbers may be conveniently entered. When the user is required to input a continuous series of numbers, for example, a phone number, or credit card number, a numeric entry mode is suitable. In an example embodiment, multiple entry modes may be available to the user on the device, such as, alpha/numeric entry, numeric entry, decimal entry, and symbol entry. The device may either detect the user's desired entry mode, or automatically set the entry mode based on the applications current state. For example, when the device is running a phone dialing application, numeric entry mode is automatically set.

The device may detect that the user wants to change entry modes when the user uses the UP and DOWN keys. In another embodiments, the “*” and “#” keys may be used to change entry mode. Further, any method of text of text entry may be offered by the device, including predictive text. Predictive text allows a user to enter a limited amount inputs and requiring the application to attempt to determine the text entered.

Entry modes—Alphanumeric Entry

Alphanumeric entry may be interpreted by the device's alphanumeric entry subroutine 706. In alphanumeric entry mode, the functions of FIG. 2 and FIG. 3 apply to text entry. Additionally, the RIGHT key may also be assigned the SPACE function. Text is entered by detecting the user pressing the number that contained the assigned ITU letter. For instance, to type the letter ‘a’ the device detects the “2” key being pressed. If the letter ‘b’ is desired, the device will detect the user pressing the “2” key in rapid succession. The time between key presses may be set by the device and may be adjusted in different embodiments. The device may also detect the user pressing and holding a key, in which case the application will rotate between the ITU assigned letters and the number; for instance, the “2” key may create repeated series displaying, ‘a’, ‘b’, ‘c’, and “2”. When the user has reached the alphanumeric character desired, the key is released. In another embodiment, commonly used symbols may be added to the repeated series. For example, an alphanumeric the “2” key may create a repeated series displaying, ‘a’, ‘b’, ‘c’, “2”, and ‘?’.

Entry modes—Numeric Entry

Numeric entry may be interpreted by the device's numeric entry subroutine 707. When the device's application is set to numeric entry, the keys on the numeric keypad 102 input the number assigned. In numeric entry mode, when the device detects the user pressing the same key, it does not create a repeated series, but instead repeats the inputted number.

### Decimal Entry

Decimal entry may be interpreted by the device's numeric entry subroutine 707 and integrates commands from the user interface logic 701. In decimal entry mode, numbers and numeric related symbols are accessible to the user. For example, the symbols to represent decimal point, and negative values may be required by the application to interpret a decimal number accurately. In an example embodiment, the decimal entry mode would contain these functions in a repeated series similar to the ITU assigned letters for alphanumeric entry. For example, the repeated series for the “1” key may be: “1” and ‘.’. Each numeric key may further contain similar repeated series.

### Symbol Entry

A user is often required to input symbols and special characters into the program. A device's symbol entry subroutine 708 may interpret key presses for symbol entry. In another embodiment of the invention, commonly used symbols may be added to the repeated series for the numeric keys. For example, in symbol entry mode, the “2” key may create the repeated series: “a”, “b”, “c”, “$”, “2”, “=”. Each numeric key may further contain similar series.

### Soft Keys

Many mobile phone and other mobile devices typically contain soft keys 106, 107 which are keys that do not perform any specific default function. The soft key 106, 107 receives its assigned function by the application. Typically a device will describe the function on a display 103 positioned near the soft key 106, 107. As the user interacts with the application, the application can change the assigned functions of the soft keys to options that are convenient to the current state of the application. In an example embodiment, two soft keys 106, 107 may be available on a device and controlled by the soft key subroutine 709.

### Options in Applications

Typically, devices contain applications that allow the selection of options through lists, checkboxes, dropdown menus, and radio dialogs. In an example embodiment, a device would detect a user scrolling through options on the device by pressing the UP and DOWN keys. The device may interpret these key presses through an option selection subroutine 705.

Radio dialogs and checkboxes are options that require a user to select from a list and activate their choice. Radio dialogs typically allow only one selection per list, while checkboxes may be selected or deselected independently. For radio dialogs and checkboxes, the RIGHT key will select or activate the highlighted option.

In another example embodiment, the device may allow a user to scroll through a list and select a listing with the RIGHT key. The device may then allow a sub-list, and allow the user to select an option from the sub-list. This allows the device to provide a “tree structure” to option selection. Further, in an alternate example embodiment, the UP and DOWN keys may be replaced by the “*” and “#” keys.

### Navigation

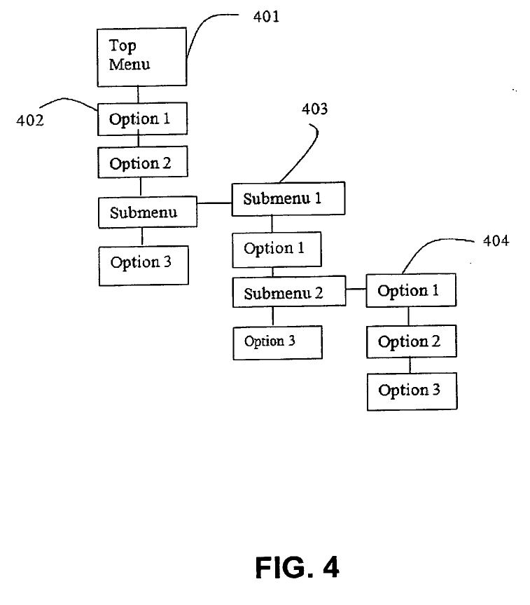

Applications typically allow a user to activate a menu, typically referred to as a pop-up menu. FIG. 4 illustrates a sample menu, in accordance with an example embodiment. In an example embodiment, the menu 401 is activated when the device detects the user holding the “#” key for a fixed duration, for example 300 ms. The duration is measured by the device's timer function. In other sample embodiments, a soft key on the device may be used to activate the menu 401. When the device activates the menu 401, the device allows the user to scroll through the options 402, 404 of the menu 401 with the UP and DOWN keys. The device allows navigation of the menu 401 and allows the user to select an option using the “#” key. If the option is a submenu 403, the device may assign “*” key to allow the user to return to a previous menu 401.

In an alternate embodiment, the device may assign “*” key to be used in the top-level menu 401 to deactivate the menu function. Applications also typically require a user to navigate through a series of fields 104, 105 in a form. In the example embodiment, the device may set the “#” key to advance from the text field 104 to the next text field 105. The device may also set the “*” key to return from the text field 105 to the previous field 104.

### Special Commands

Applications typically contain commands for common functions, such as, “Copy,” “Paste,” and “Help.” These commands may be universal to any application currently running on the device. For instance, the “Help” command may provide instructional information about the current program. While these commands are typically available through a menu, an example embodiment would contain “shortcuts” to these commands. To accomplish this on a limited keypad, an example device would contain a program to detect a user entering a key combination and subsequently carrying out an assigned function. For example, the device may assign the “#” key or any other key to act as a command button. When the device detects the combination of pressing the “#” key followed by the “1” key with in a fixed duration measured by a timer program, the application executes the “Help” command.

### Computer System

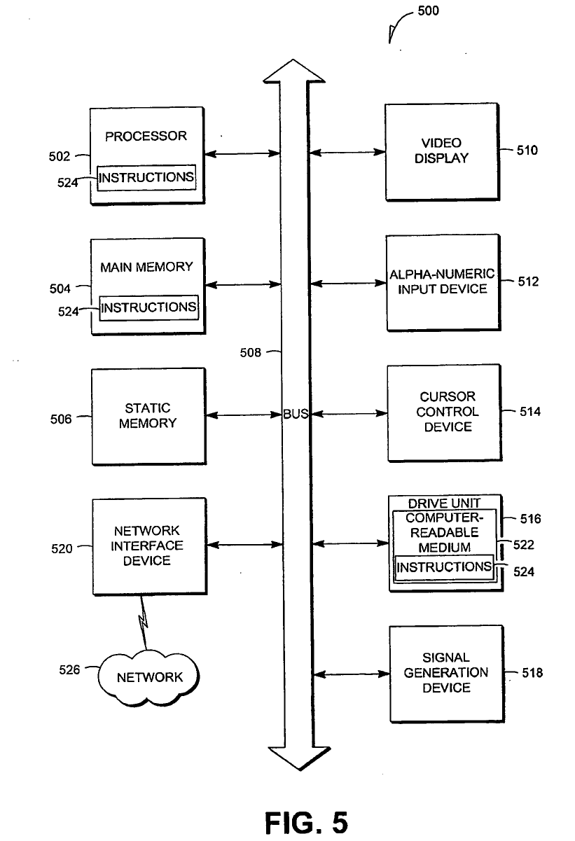

FIG. 5 is a block diagram of machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Example embodiments may be implemented in digital electronic circuitry, or in computer hardware, firmware, software, or in combinations of them. Example embodiments may be implemented as a computer program product, e.g., a computer program tangibly embodied in an information carrier, e.g., in a machine-readable storage device or in a propagated signal, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, example embodiments may be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules may include hardware circuitry, optical components, single or multi-processor circuits, memory circuits, software program modules and objects, firmware, and combinations thereof, as appropriate for particular implementations of various embodiments.

### Application Logic

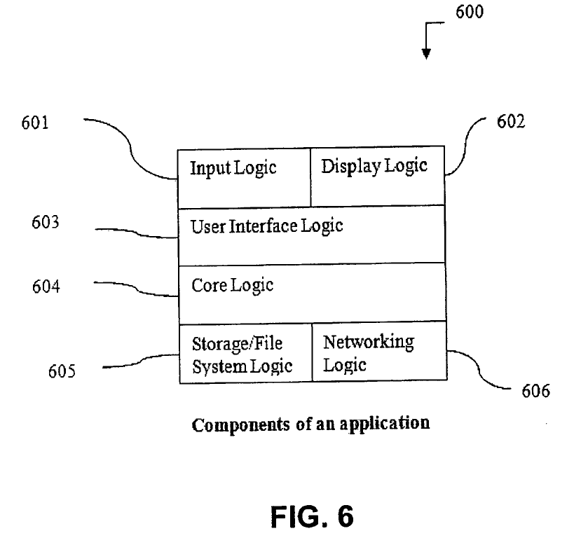

FIG. 6 is a block diagram of the components of a sample application 600. An application may run on a computer system 500 to allow a user to interact with a device. In an example embodiment, the application would comprise components to manage different tasks. The input logic 601 may be responsible for interpreting user input. The display logic 602 may be responsible for displaying data. The display logic may output data from the application to the display 103. The user interface 603 may allow the device to interpret interaction with the user. The user interface 603 is discussed in further detail below. The core logic 604 comprises the basic components of the application that are necessary for functionality. The storage/file system logic 605 is responsible for storing data. The storage/file system logic 605 allows the application to interact with memory-type devices. Finally, the network logic 606 is included to allow the computer system 500 to communicate with other devices. Communication with other devices may include transferring data between a server and a client or between two like devices.

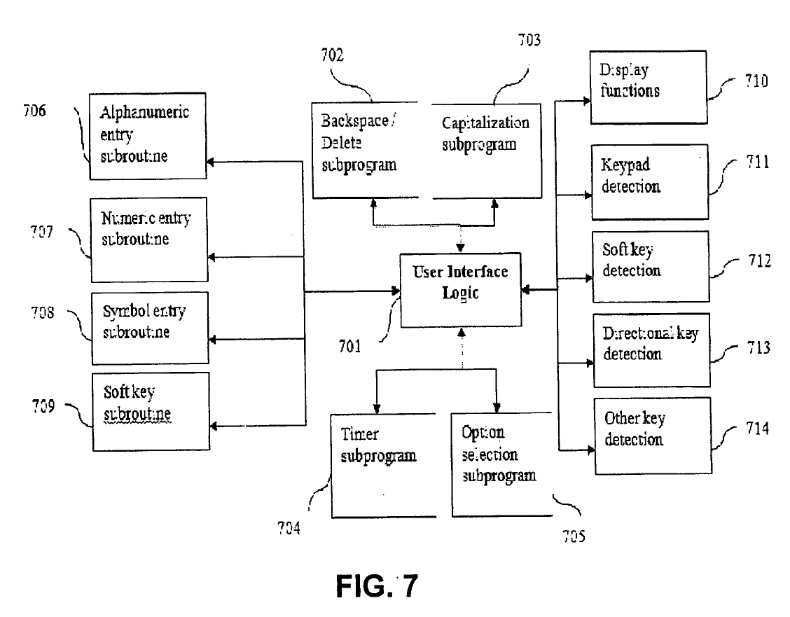

FIG. 7 is a block diagram of a program in the example form of an application. An example computer program would contain, among others, the basic architecture and user interface 701. The user interface 701 is responsible for interpreting user key presses, input events and to carryout functions based on the inputs. The user interface would also contain subprograms written in any programming languages to carryout the described backspace/delete function 702, capitalization function 703, and option selection subprogram 705. The program would further contain at least one timer subprogram 704 to detect the duration of key presses.

The user interface 701 would further contain subroutines to process inputted data through the various entry modes, in an example embodiment, this would include the alphanumeric entry mode 706, numeric entry mode 707, and symbol entry mode 608. In alternate example embodiments where soft keys 107 are available, an additional subroutine for soft key programming 709 may be included. The user interface 701 may further include modules to detect and process commands. These modules may include the display function 710, to manage the data on the display 103. Further modules may process input from the keypad 711, soft keys 712, direction keys 713, and any other keys 714.

### EXAMPLE USE OF EMBODIMENT

An example embodiment may include the computer system 500 as a mobile phone device running a mobile phone operating system as associated applications 600. To perform functions on the mobile phone, a user may interact with the user interface 701. The user may activate a messaging program. The device, through its input logic 601, may detect the user pressing and holding the “#” key. The device's timer subprogram 704 and core logic 604 detects the length the user holds the “#” key and if the duration is longer than 300 ms, a menu 401 appears on the display 103. The device may further detect the user navigation to the messaging program with the UP and DOWN key as an option 402. When the messaging program option 402 is selected, the device detects the user's press of the “#” key to activate the option.

After invoking a messaging program, the device may display multiple fields 104, 105 for the user to enter message, subject and destination information. The device allows the user to navigate between the fields by detecting user's key presses of the “*” and “#” keys. The device detects the user's text input through the keypad 101. Further, the device allows the user to change entry modes by detecting presses of the DOWN key. The device may detect the user selecting the DOWN key to change to alphanumeric entry mode. As the user uses alphanumeric mode to type a message, the device may allow the user to advance forward and backwards a character by detecting input from the RIGHT and LEFT keys, respectively.

If the devices timer subprogram 704 detects a LEFT key press and held for greater than 300 ms, Delete Mode is activated. The timer subprogram 704 continues to detect the length of key presses, and if 1.5 seconds elapse without a key press, Delete Mode is deactivated. While composing the message, the user may also be required to change Capitalization Modes. For example, if the user needs to enter an entire section of text in capital letters, the device may detect the user press and hold the UP key. If the timer subprogram 704 detects that the user has held the key for more than 300 ms, the device set CAPS LOCK mode.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method to use a key pad of a mobile device to interact with an application, the method comprising:
determining input requirements of the application;
mapping each of the input requirements of the application to a group of one or more keys in the key pad of the mobile device; and
enabling a user of the mobile device to interact with the application using the keypad.

2. The method of claim 1, wherein the one or more keys in the keypad comprises numeric keys and directional keys, wherein the numeric keys include keys for numbers 0 to 9 and keys for character “*” and character “#”, and wherein the numeric keys conform to International Telecommunication Union (ITU) standard.

3. The method of claim 2, wherein mapping each of the input requirements of the application comprises mapping one or more keys of the keypad to implement BACKSPACE and DELETE functions.

4. The method of claim 3, wherein the directional keys include a LEFT key, and wherein the LEFT key is associated with the BACKSPACE or the DELETE function.

5. The method of claim 4, wherein the DELETE function is performed when the LEFT key is selected for more than a predetermined time period.

6. The method of claim 3, wherein the directional keys include a RIGHT key, and wherein the RIGHT key is associated with the BACKSPACE or DELETE function.

7. The method of claim 6, wherein the RIGHT key is used when being associated with text reading from right to left.

8. The method of claim 2, wherein mapping each of the input requirements of the application comprises mapping one or more keys of the keypad to implement a CAPITALIZATION function.

9. The method of claim 8, wherein the directional keys include an UP key, and wherein the UP key is associated with the CAPITALIZATION function.

10. The method of claim 9, wherein when the UP key is selected twice, the CAPITALIZATION function is set, and when the UP key is again selected twice the CAPITALIZATION function is reset.

11. The method of claim 2, wherein mapping each of the input requirements of the application comprises mapping one or more keys of the keypad to implement a SPACE function, an ENTER/RETURN function, and a BACK function.

12. The method of claim 11, wherein the each of the SPACE function, the ENTER/RETURN function, and the BACK function is mapped to a numeric key.

13. The method of claim 2, wherein mapping each of the input requirements of the application comprises mapping one or more keys of the keypad to implement entry mode, wherein the entry mode includes numeric entry mode and alphanumeric entry mode.

14. The method of claim 13, wherein the numeric entry mode includes decimal entry.

15. A method to detect user's navigation among various fields in a form, and from form to form of multiple forms, using keypads on a mobile device, the method comprising:
mapping functions of a form application to keys of an alphanumeric keypad and keys of a directional keypad;
using the keys of the directional keypad to navigate from a first form to a second form of the form application; and
using the keys of the alphanumeric keypad to enter information into form fields of the first form and/or of the second form, wherein the keys of the navigational keypad and the keys of the alphanumeric keypad are associated with mapping logic that enable these keys to interact with the form application.

16. The method of claim 15, wherein the keypad is an International Telecommunication Union (ITU) standard 3×4 keypad, wherein the keypad enables a user to display a context sensitive menu by detecting presses from the ITU standard 3×4 keypad.

17. The method of claim 16, further comprising:
detecting a specially designated key press as a specialized function key; and
detecting a number key press, within a fixed duration measured by a timer subroutine.

18. The method of claim 17, wherein said detecting a designated key press or said detecting a number key press within a fixed duration is interpreted as commands for one or more of text edit and text entry.

19. A system to interpret user's commands using an International Telecommunication Union (ITU) standard 3×4 numeric keypad and a directional keypad, comprising:
logic to detect when one or more keys of the numeric key pad and the directional keypad is selected;
logic to detect a duration of time the selected one or more keys stays selected; and
logic to interpret to the detection of selected keys and selected duration into commands to interact with an application, wherein the numeric key pad and the directional key pad are associated with a mobile device.

20. The system of claim 19, further comprising logic to enable a user to switch between a numeric entry mode and an alphanumeric entry mode to enable the user to interact with the application.
